(19) United States
(12) Patent Application Publication
(10) Pub. No.: US 2003/0174442 A1
(43) Pub. Date: Sep. 18, 2003

(54) Marker for indicating degaussing of magnetic storage devices

(76) Inventors: Robert Guisinger, Beavercreek, OH (US); T. Randall Lane, Lebanon, OH (US)

Correspondence Address: SHOOK, HARDY & BACON, 1200 MAIN STREET, ONE KANSAS CITY PLACE, KANSAS CITY,, MO, 64105-2118, US

(21) Appl. No.: 10/349,767

(22) Filed: Jan. 23, 2003

Related U.S. Application Data
(60) Provisional application No. 60/351,057, filed on Jan. 23, 2002.

(51) Int. Cl. G11B 5/74

(52) U.S. Cl. 360/131

(57) ABSTRACT

A tag or marker applied to a magnetic digital information storage device undergoes a visually observable change when subjected to a magnetic field of preselected intensity to provide visual evidence that the storage device has been degaussed or otherwise subjected to a magnetic field. The tag or marker comprises microcapsules containing an encapsulated mixture of magnetic particle suspended in a suspending vehicle. The magnetic particles have first and second surfaces that provide a visually different appearance depending upon the orientation of the magnetic particles. Upon exposure to the magnetic field of preselected strength or intensity, the magnetic particles change orientation to provide the visual evidence of degaussing.

### CROSS-REFERENCE TO RELATED APPLICATIONS

This application claims the benefit of provisional application Serial No. 60/351,057, filed Jan. 23, 2002.

### BACKGROUND OF THE INVENTION

Digital information is stored on a variety of different types of storage devices, including magnetic and magneto-optical tapes, disks and the like. On most types of such magnetic storage devices, the digital information previously recorded on the device can be erased by subjecting the device to a magnetic field in a process commonly referred to as degaussing. The ability to degauss and then reuse magnetic storage devices is problematic from the standpoint of making it difficult to differentiate between new and used storage devices. As a result, used storage devices may be passed off as new to unsuspecting customers. A need has thus developed for a way to distinguish between new and degaussed magnetic storage devices so that consumers are not mislead as to the condition of the storage devices.

### SUMMARY OF THE INVENTION

In one aspect, the present invention is directed to a tag or marker that can be applied to a magnetic digital information storage device and undergoes an optically observable change when subjected to a magnetic field of a preselected intensity so that the marker provides visually observable evidence that the storage device has been degaussed or has otherwise been subjected to the magnetic field.

In another aspect, the invention is directed to a method of providing a visually observable indication as to whether the magnetic storage device has been subjected to degaussing by applying to the storage device a marker that changes optical properties when subjected to a magnetic field of a preselected intensity.

The tag or marker comprises a layer of magnetically sensitive microcapsules applied to a protective substrate that is at least partially translucent. An opaque background layer is applied on top of the layer of microcapsules and an adhesive is applied on top of the background layer to adhere the tag or marker to the magnetic digital storage device. The microcapsules contain a mixture of magnetic particles in a suspending vehicle, along with other optional components such as a dispersing agent, a viscosity thickener or thinner, and a colorant. The magnetic particles have first and second surfaces that provide a visually observable indication of the orientation of the magnetic particles. For example, the first surface can have a greater surface area than the second surface or the first surface can have a different surface treatment than the second surface. When the magnetic particles are subjected to a magnetic field of preselected strength or intensity, the magnetic particles change orientation in the suspending vehicle to provide the visually perceptible indication that the magnetic storage device has been degaussed. An individual may thus determine that the magnetic storage device is not in a new condition by simply observing the condition of the tag or marker.

### BRIEF DESCRIPTION OF THE DRAWING

In accompanying drawings which form part of the specification and are to be read in conjunction therewith and in which like reference numerals are used to indicate like parts in the various views:

FIG. 1 is a side elevation view of a degaussing marker of the present invention and shown on an enlarged scale.

FIG. 2 is a perspective view of a magnetic storage device to which the degaussing marker has been applied, the marker having a first optical condition indicating that the storage device has not been subjected to a magnetic field of a preselected intensity;

FIG. 3 is a perspective view of the magnetic storage device shown in FIG. 2, but with the degaussing marker having a second optical condition resulting from subjecting the storage device to a magnetic field of preselected intensity

### DETAILED DESCRIPTION OF THE INVENTION

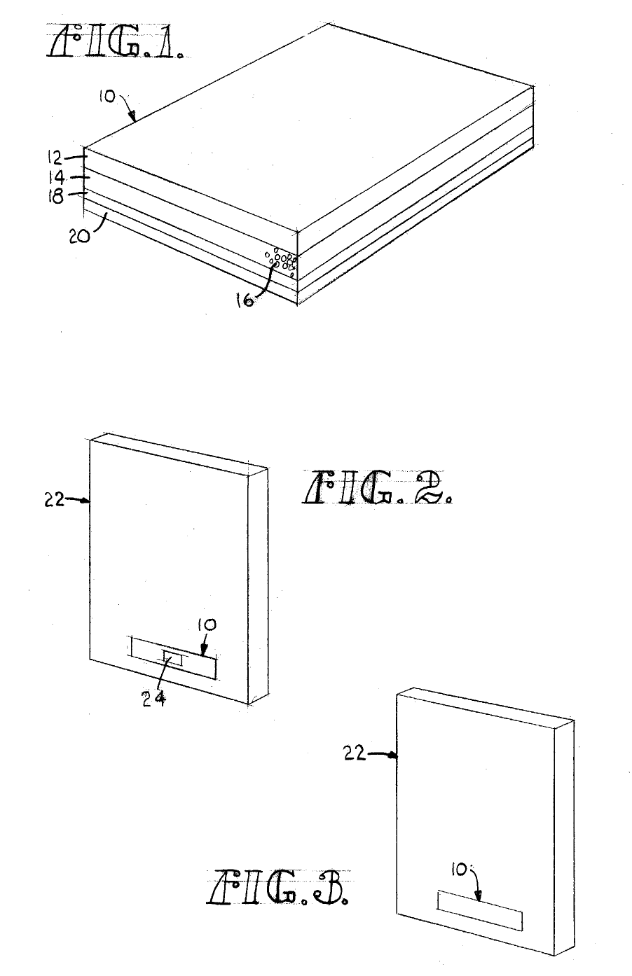

Turning now to the drawings in greater detail and initially to FIG. 1, a degaussing marker of the present invention is designated broadly by the numeral 10 and comprises a substrate 12 coated with a layer 14 of magnetically sensitive microcapsules 16, which in turn is coated with an opaque background layer 18. An adhesive 20 is applied to the background layer 18 to allow the marker 10 to be adhered to a suitable product such as a magnetic storage device 22 as shown in FIGS. 2 and 3. The substrate 12 is preferably at least partially translucent, is dimensionally stable, and must be capable of adhering the microcapsules. Examples of suitable substrate 12 materials include polyester films available from DuPont Teijin Films under the MYLAR and MELINEX trademarks.

The magnetically sensitive microcapsules 16 comprise an encapsulated mixture of magnetic particles in a suspending vehicle and, optionally, a dispersing agent, a thickener, and a colorant. The magnetic particles are formed of any material that is or can be converted into a magnetically responsive particle having first and second surfaces that present visually detectable differences in appearance. A preferred method of creating these differences in appearance is to form the first surface with a much greater relative surface area than the surface area of the second surface. Other methods may, of course, be used. For example, the first and second surfaces may be textured or otherwise formed in a manner so that they have different light refractive indices. The first and second surfaces are preferably, but not necessarily, located in perpendicular planes. A preferred configuration for the magnetic particles is a thin and generally flat circular plate. The size of the magnetic particles can be varied, but preferably will pass through a 325-mesh sieve containing 44 micron openings.

Examples of suitable materials that can be used for the magnetic particles include metals such as cobalt, nickel, stainless steel and iron, as well as mixtures and alloys of these metals. It is to be understood, however, that other materials can be used for the magnetic particles. The magnetic particles are preferably a mixture of flakes of one or more metals mixed together in relative amounts to create a mixture having the desired magnetic sensitivity. A sensitizer that allows the magnetic sensitivity of the mixture to be increased or decreased can be added if desired. The sensitizer preferably comprises flakes of one or more other metals or materials that are either more sensitive or less sensitive to the magnetic field than the mixture of metals. The responsiveness of the magnetic particles can also be controlled by selecting flakes of different sizes.

The suspending vehicle is a fluid in which the magnetic particles are dispersed. The suspending vehicle should have a sufficiently high viscosity to maintain the magnetic particles in preselected alignment until the magnetic particles are exposed to a magnetic field of a preselected intensity. The viscosity of the suspending vehicle should also permit the magnetic particles to change orientation once exposed to the magnetic field of preselected strength. The suspending vehicle should also be at least partially transparent or translucent to permit visual observation of the orientation of the magnetic particles. Various types of oils such as silicone oil, vegetable oil, and mineral oil are well suited for use as the suspending vehicle. Other types of non-water soluble oily liquids may also be utilized. The viscosity of the suspending vehicle can also be modified to vary the ease with which the magnetic particles may change orientation.

An optional thickener such as colloidal silica, silicon dioxide or fumed silica can be added to the suspending vehicle to increase the viscosity thereof. The thickener can be hydrophilic or hydrophobic. A preferred thickener is hydrophobic fumed silica that has been treated with dimethyldichlorosilane and is available under the trademark AEROSIL R972 from Degussa Aktiengesellschaft. By increasing the viscosity of the suspending vehicle, it becomes more difficult for the magnetic particles to change orientation, and a higher strength magnetic field must be applied to change the orientation of the magnetic particles. Conversely, an optional thinner can be used to reduce the viscosity of the suspending vehicle and thereby reduce the strength of the magnetic field required to change the orientation of the magnetic particles. Mineral spirits is one example of a suitable thinner.

The optional dispersing agent is added to the mixture in order to aid in the dispersion of the magnetic particles in the suspending vehicle and to prevent or reduce agglomeration of the magnetic particles. The dispersing agent can be selected from, but is not limited to, various anionic, cationic and non-ionic surfactants. For example, the dispersing agent can be any of various sorbitan fatty acid esters, such as sorbitan trioleate having a hydrophile-lypophile balance (HLB) number of 1.8 and available from ICI Americas Inc. under the trademark SPAN 85V, sorbitan monolaurate having an HLB number of 8.6 and available from ICI Americas Inc. under the trademark SPAN 20, sorbitan monooleate having an HLB number of 4.3 and available from ICI Americas Inc. under the trademark SPAN 80, and sorbitan sesquioleate having an HLB number of 3.7 and available from ICI America Inc. under the trademark ARLACEL 83. Numerous other dispersing agents, individually and in combination, can be used.

The optional colorant is preferably an oil-soluble dye and can be added to the mixture to change the color thereof or to provide a more uniform color. Other additives and excipients can be added to the mixture. For example, titanium dioxide can be added as an opacifier, fluorescent dyes can be used to allow detection of counterfeit labels, and UV brighteners can be used to enhance the appearance of the label.

The components of the encapsulated mixture can be present in various relative quantities and can be mixed together using known techniques and conditions. As one example, the mixture comprises magnetic particles in an amount of 1-25% by weight, suspending vehicle in an amount of 45-99% by weight, dispersing agent in an amount of 0-10% by weight, thickener/thinner in an amount of 0-10% by weight, and colorant in an amount of 0-10% by weight. A more preferred mixture comprises magnetic particles in an amount of 5-25% by weight, suspending vehicle in an amount of 60-95% by weight, dispersing agent in an amount of 0-5% by weight, thickener/thinner in an amount of 0-5% by weight, and colorant in an amount of 0-5% by weight. A still more preferred mixture comprises magnetic particles in an amount of 10-20% by weight, suspending vehicle in an amount of 75-90% by weight, dispersing agent in an amount of 0-1% by weight, thickener/thinner in an amount of 0-3% by weight, and colorant in an amount of 0-1% by weight. A particularly preferred formulation comprises silicone oil in an amount of 79% by weight, cobalt flakes in an amount of 18.5% by weight, colloidal silicon dioxide thickener in an amount of 2% by weight, sorbitan trioleate (SPAN 85V) in an amount of 0.5% by weight, and dye in an amount of 0.1% by weight. As used herein, the quantities expressed are by weight of the overall mixture.

Any of numerous types of known coating materials are used to form the at least partially transparent or translucent walls of the microcapsules containing the magnetically sensitive mixture. Among these known materials are gelatin, a mixture of gelatin and gum arabic, a mixture of gelatin and carboxymethylcellulose, a mixture of gelatin and carrageenan, a mixture of gelatin and sodium alginate, a mixture of gelatin and polyphosphate, a mixture of urea and formaldehyde, and a mixture of melamine and formaldehyde. An example of a suitable coating material used to encapsulate the magnetically sensitive mixture is a mixture of gelatin and carboxymethylcellulose, with glutaraldehyde used to cross-link and insolubilize the coating or walls of the microcapsules. The size and wall thickness of the microcapsules 16 can be varied to suit particular applications. Preferably, the microcapsules 16 have a diameter of less than 80 microns and a wall thickness of approximately 2-8 microns. It will be appreciated that microcapsules with a greater wall thickness may be desired in those applications requiring more rugged and durable microcapsules. As one example, the finished microcapsules can contain 70-98% by weight encapsulated mixture and 2-30% by weight microcapsule wall.

The microcapsules 16 can be formed using known techniques such as a complex coacervation process, but other techniques can be used as well. The microcapsules 16 are preferably prepared, washed and preserved and are then concentrated to form a paste using gravity filtration. The paste is then mixed with equal portions of a binder solution such as 1-2% polyvinyl alcohol and applied to the substrate 12 by any of various techniques such as flood coating or a drawdown slurry process to form layer 14. An optional water soluble dye can be added to the mixture to match the color of the microcapsules to provide a more uniform appearance to the coating layer 14. The layer 14 is then allowed to dry and is overcoated with black ink or other opaque material to form the opaque background layer 18. The adhesive 20 is then applied to the background layer 18 to allow the marker 10 to be cut to size and adhered to a magnetic storage device 22. The adhesive 20 is preferably a permanent adhesive to prevent the marker 10 from being readily removed from the storage device 22.

Although the marker 10 is preferably prepared and then applied to the magnetic storage device 22 in the form of a tag or label, it is to be understood that the marker 10 can be formed directly on the storage device 22.

As an added safeguard, the marker 10 can be applied over a warning that is printed on the storage device 22 and is visible only when the marker 10 has been removed from the storage device 22. The warning can convey the message using words and/or symbols indicating that the degaussing marker 10 has been removed from the storage medium.

Turning additionally to FIG. 2, the degaussing marker 10 is shown applied to an externally visible surface of the magnetic storage device 22. The magnetic storage device 22 is representative of any of various types of storage media capable of storing digital information. For example, the magnetic storage device 22 may comprise a magnetic tape, such as a digital linear tape, or a magnetic disk and includes those types of media that use magnetism in combination with optical or other properties to store digital information.

The degaussing marker 10 may also carry a marking 24, such as the manufacturer's trademark or logo, that is erased when the marker 10 is exposed to a magnetic field of a preselected strength. The marking 24 is formed by subjecting the marker 10 to a controlled electric current at preselected locations to cause the magnetic particles in the microcapsules 16 in the area of the marking 24 to have a different orientation than the magnetic particles in the surrounding microcapsules.

In use, when the marker 10 is exposed to a magnetic field of a preselected strength the preset orientation of the magnetic particles in the microcapsules 16 is disrupted and the visual appearance of the marker 10 is changed. This change in visual appearance can include erasure of the marking 24 as shown in FIG. 3 and a change in color of the marker 10. For example, the marker 10 could change to an iridescent color that would alert the consumer to the fact that the magnetic storage device 22 has been exposed to a magnetic field such as would be experienced during erasure of digital data stored on the storage device 22. The marker 10 thus allows a consumer to differentiate between a new storage device 22 and one that may have been previously used and erased. Notably, by varying the size of microcapsules 16, the size of the flakes of magnetic particles contained within the microcapsules 16, and the viscosity of the suspending vehicle, the magnetic sensitivity of the marker 10 can be varied to suit particular applications. For example, the marker 10 can be preset to react to magnetic fields within the range of 2 to 500 gauss.

The following examples are provided for exemplification purposes and are not to be interpreted in a limiting sense.

### EXAMPLE 1

### Microencapsulation Process

To prepare the microcapsules, 200 g deionized water, 10 g gelatin, and 1 g carboxymethylcellulose are added to an 800 ml beaker and are mixed and heated to 50 degrees C. until the gelatin and carboxymethylcellulose have dissolved in the water. A 20% NaOH solution is added dropwise to the mixture until the solution clears. The magnetic particle dispersion is added slowly to the mixture and is milled until all droplets are less than 100 microns in size. The batch is allowed to cool to 40 degrees C. and then 300 g deionized water preheated to 40 degrees C. is added. The pH of the batch is adjusted to 5.25 by adding dilute acetic acid and the batch is then cooled slowly to 28 degrees C. The batch is then cooled quickly to 10 degrees C. by placing it in an ice water bath. 2.5 ml of a 50% glutaraldehyde solution is added and the batch is then removed from the ice water bath and allowed to warm to room temperature. After stirring the batch at least 12 hours, the microcapsules are allowed to settle to the bottom of the beaker and the liquid layer is decanted and replaced with an equal amount of deionized water. The batch is stirred and immediately poured into a filter-lined funnel and allowed to concentrate to form a microcapsule paste containing about 35% by weight of microcapsules.

### EXAMPLE 2

### Manufacture of Label

The concentrated microcapsule paste from Example 1 is thoroughly mixed with equal parts of 1-2% polyvinyl alcohol binder solution. A water soluble dye is added to the mixture to match the color of the microcapsules. The mixture is then applied by flood coating or drawdown slurry techniques to form a coating approximately 30-50 mils in thickness on a polyester film substrate having a thickness of 1-4 mils. The coating is allowed to dry several hours at room temperature or in an oven. After drying, the coating is approximately 5-10 mils in thickness. The coating is then overcoated with black ink and allowed to thoroughly dry. Two-sided black tape is then applied to the ink side to form the completed label. The magnetic particles are then aligned in a preset orientation by exposure to an orienting magnetic field. The completed label has a sensitivity starting at approximately 20-30 gauss. A magnetic field of around 100 gauss causes a more complete and readily observable change in the orientation of the magnetic particles in the suspending vehicle.

From the foregoing, it will be seen that this invention is one well adapted to attain all the ends and objectives hereinabove set forth together with other advantages which are inherent to the structure.

It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative and not in a limiting sense.

Having thus described the invention, what is claimed is:

1. A degaussing indicator article comprising:
a substrate;
a layer of microcapsules applied to the substrate, said microcapsules comprising walls encapsulating a mixture comprising magnetic particles in a suspending vehicle, said suspending vehicle having a preselected viscosity sufficient to maintain said magnetic particles in a first preset orientation and then allow said magnetic particles to rotate to one or more other orientations upon exposure of the magnetic particles to a magnetic field of a preselected intensity.

2. The article of claim 1, wherein the suspending vehicle is selected from the group consisting of silicone oil, vegetable oil, and mineral oil.

3. The article of claim 1, wherein the magnetic particles have a configuration of a flat, circular plate.

4. The article of claim 1, wherein the magnetic particles are sized to pass through a 325-mesh sieve having 44 micron openings.

5. The article of claim 1, wherein the magnetic particles each have first and second surfaces having different visual appearances.

6. The article of claim 5, wherein said first surface has a greater surface area than said second surface.

7. The article of claim 5, wherein said first surface has a different light refractive index than said second surface.

8. The article of claim 1, wherein said magnetic particles are selected from one or more of the group consisting of cobalt, nickel, iron and stainless steel.

9. The article of claim 1, wherein the suspending vehicle is present in an amount of 45 to 99% by weight based on the total weight of the mixture and said magnetic particles are present in an amount of 1 to 25% by weight based on the total weight of the mixture.

10. The article of claim 9, wherein the mixture includes a viscosity thickener present in an amount of up to 10% by weight based on the total weight of the mixture.

11. The article of claim 9, wherein the mixture includes a dispersing agent present in an amount of up to 10% by weight based on the total weight of the mixture.

12. The article of claim 9, wherein the mixture includes a colorant present in an amount of up to 10% by weight based on the total weight of the mixture.

13. The article of claim 1, wherein the substrate comprises a polyester film.

14. The article of claim 1, including an opaque background layer applied to said layer of microcapsules on a side opposite from said substrate.

15. The article of claim 14, including an adhesive applied to said background layer on a side opposite from said layer of microcapsules.

16. A magnetic digital information storage device having applied thereto a degaussing article of claim 1.

17. A method for forming a degaussing tag or marker comprising:
(a) mixing together magnetic particles and a suspending vehicle to form a mixture;
(b) encapsulating said mixture within microcapsules;
(c) applying a layer of said microcapsules to a substrate; and
(d) applying an opaque background coating to said layer of microcapsules opposite from said substrate.

18. The method of claim 17, including adhering said tag or marker to a magnetic digital information storage device with said opaque background coating being positioned closest to said storage device.

19. The method of claim 17, wherein said step of forming a mixture comprises mixing magnetic particles of different magnetic materials with said suspending vehicle.

20. The method of claim 17, including adding one or more of a viscosity thickener, dispersing agent and colorant to said mixture prior to said step of encapsulating said mixture.
